(19) United States
(12) Patent Application Publication
(10) Pub. No.: US 2025/0388215 A1
(43) Pub. Date: Dec. 25, 2025

(54) Method and Assistance System for an Information Filter-Based Driving Tube Estimate for a Motor Vehicle

(71) Applicant: Bayerische Motoren Werke Aktiengesellschaft, Muenchen (DE)

(72) Inventors: Michael HIMMELSBACH, Muenchen (DE); Christian LENK, Muenchen (DE); Alexandros THEODORIDIS, Muenchen (DE)

(21) Appl. No.: 18/877,666

(22) PCT Filed: Jun. 1, 2023
(86) PCT No.: PCT/EP2023/064680

§ 371 Date: Dec. 20, 2024

(30) Foreign Application Priority Data
Jun. 23, 2022 (DE) 10 2022 115 720.2

(51) Int. Cl. B60W 40/072; B60W 40/04

(52) U.S. Cl. CPC B60W 40/072; B60W 40/04

(57) ABSTRACT

The present disclosure relates to a method and to an assistance system for the repeated estimation of a current driving tube of a motor vehicle, wherein the method is able to be performed repeatedly at regular intervals during operation of the motor vehicle, and the disclosure further relates to a correspondingly configured motor vehicle. In the method, multiple measured data, which characterize a respective traffic situation of the motor vehicle, are recorded with associated uncertainties. An updated information matrix and an updated information vector of the information filter-based formalism are thus each estimated in an update step. An updated estimate of the driving tube is then determined from the updated information matrix and the updated information vector.

### BACKGROUND AND SUMMARY

The present disclosure relates to a method and an assistance system for estimating a driving tube of a motor vehicle during its operation. The disclosure further relates to a correspondingly configured motor vehicle.

Measures are currently being taken for increasing automation of vehicle guidance and for the further improvement of assistance functions and systems of motor vehicles. The most accurate possible estimate, thus prediction of the driving tube of the respective motor vehicle can be useful as the basis for this purpose. Such a driving tube, which can also be referred to as a driving corridor, indicates an area lying in front of the motor vehicle in the travel direction thereof, through which or along which the motor vehicle is at least expected to move. Such a driving tube can be delimited, for example, by road edges or the like and/or by defined edges.

A method for detecting road edges on a road to detect a free path is described, for example, in DE 10 2013 205 950 B4. Line candidates are detected therein based on input images and an initial vanishing point in an image is identified as a function of the line candidates. For each line candidate, a region of interest in the image is identified, wherein each region of interest comprises a line candidate and a surrounding region. Features which relate to the line candidates and were extracted from the region of interest are input into a classification device in order to identify whether the line candidate is a potential road edge. The classification device assigns a confidence value to the line candidate, which identifies a probability with respect to it as to whether the line candidate is a road edge. The potential line candidate is identified as a reliable road edge based on the confidence value being greater than a predetermined value.

As described, for example, in DE 10 2006 040 334 A1, the current speed of the respective vehicle and its yaw rate can be used to estimate the driving tube. However, corresponding known methods are not always adequate for more complex driver assistance systems. Therefore, a method for lane sensing is proposed therein. Lane markings in an area lying in front of the vehicle are sensed therein using a sensor system of the vehicle. Support points having coordinates of a first coordinate system are assigned to the lane markings, which are then converted into a second coordinate system. The course of lane markings and/or lanes is reconstructed from the location of the support points in the second coordinate system.

A method for ascertaining roadside structure information, which describes roadside structures along a route traveled by a motor vehicle, is disclosed in DE 10 2016 003 935 A1. Trajectory data, which describe the trajectory of the motor vehicle in the past and/or a projected trajectory of the motor vehicle, are used as input data here. In the method, an ascertainment area covering the described trajectory is divided into interval areas perpendicular to the vehicle longitudinal direction. For each interval area, sorting of obstacle positions located within the interval area is carried out depending on the location of the trajectory as associated with left or right roadside structures. The roadside structure information is then ascertained from the obstacle positions located closest for each interval area of the trajectory. The roadside structure information is therefore to be able to be ascertained from sensor data provided via a generic data interface independently of a model and the specifically used types of sensor.

It has been problematic in previous approaches for estimating a driving tube that these approaches are often comparatively computing-intensive, but in motor vehicles often only limited hardware and computing resources are available, for example, control units or the like designed as embedded systems. There is thus a demand not only for improved surroundings identification and driving tube estimation, but also for a reduction of the computing power required for this purpose.

An object of the present disclosure is to enable particularly efficient estimation of a driving tube of a motor vehicle during its operation.

This object is achieved by aspects of the present disclosure. Possible embodiments are disclosed in the description and in the FIGURE.

The method according to the present disclosure can be applied to repeatedly estimate a current driving tube of a motor vehicle which lies ahead of the motor vehicle in the travel direction. The method can be applied during operation of the respective motor vehicle. The respective current driving tube can thus be repeatedly estimated continuously or regularly or the estimated driving tube can be repeatedly updated continuously or regularly by the method according to the disclosure during the journey. In one method step of the method according to the disclosure, measurement data which specify or characterize a respective traffic situation of the motor vehicle are acquired with associated uncertainties. The measurement data can be specified or organized in a vector, for example. The uncertainties can be specified or organized, for example, in an uncertainty matrix, which can in particular contain the uncertainties of the measurement data. The uncertainties can specify, for example, measurement errors, confidence intervals, or correspondingly limited accuracies of the measurement data. The uncertainties can each be provided and/or calculated by a sensor together with the respective measurement data or measurement values, for example, by a predetermined heuristic or the like.

The measurement data and the associated uncertainties thereof can form or span a measurement space together here or can be specified in a measurement space. The measurement space is thus an abstract mathematical space. If a plurality of measurement data, for example, of different types and/or for different positions or the like, are used for estimating or updating the driving tube, the measurement space can accordingly be high-dimensional. In practice, the uncertainty matrix can have, for example, in the order of magnitude of 100 rows and columns or more.

The measurement data can describe or map respective surroundings of the motor vehicle, in particular lying ahead in the direction of travel of the motor vehicle. The measurement data can also be or comprise, for example, operating data or status data of the motor vehicle, movement data of other road users, which can specify, for example, trajectories traveled by external vehicles at earlier times in the respective surroundings, and/or more of the like. In particular, the individual measurement data can be of multiple different types, can originate from multiple different sensors, can originate from different measurement points, thus measurement locations in the surroundings, and/or more of the like. This can enable particularly robust and accurate estimating or updating of the driving tube. However, a correspondingly greater data processing effort or computing effort can also be linked thereto. This problem is bypassed or avoided by the method according to the disclosure, however.

For this purpose, in a further method step of the method according to the disclosure, as soon as new measurement data are available or have been acquired, in an updating step an updated information matrix and an updated information vector are thus estimated in the context of the information filter formalism or mechanism. In other words, the or an information filter is thus used here in order to take into consideration the respective new or updated measurement data including their uncertainties in the estimating or updating of the driving tube. The information filter is a type of Kalman filter, which is also referred to in technical language as an inverse covariance filter.

In a further method step, in each pass through the method or after each updating step, an updated estimate of the driving tube is determined from the updated information matrix and the updated information vector. In other words, a state or state vector can thus be determined, which describes the driving tube according to the respective current estimate or prediction.

The application of the information filter formalism proposed here enables updating of the estimate of the driving tube without inverting the uncertainty matrix, as is typically necessary in previous approaches. Instead, individual measurements can be taken into consideration or processed independently of one another here in the updating step. For this purpose, correspondingly smaller matrices can each be inverted for a single measurement, for example, a single sensor or a single measurement point or measurement position or the like. The information matrix which is possibly to be inverted can be smaller, in particular much smaller, and can thus have a smaller dimension than the uncertainty matrix for the respective entirety of the acquired or newly acquired measurement data. In other approaches, the updating of the estimate of the driving tube by consideration of the respective new measurement data requires the inversion of the comparatively high-dimensional uncertainty matrix, which represents the uncertainties of all new measurement data or measurements in each case. The method according to the present disclosure can be carried out here with very much less computing effort in comparison to such approaches. This can enable a driving tube estimate or driving tube update which is improved, for example, by using more measurement data and/or a more frequent or high frequency update, in operation of a motor vehicle, in particular also using limited hardware or computing resources, such as currently typical control units or embedded systems.

The driving tube or its estimate can be described here by fewer parameters or values in comparison to the set or number of the measurement data and their uncertainties, so that calculation steps or method steps which are in a corresponding state space spanned by the parameters used for describing the driving tube or its state, can also be carried out with particularly little computing effort. Since a correspondingly accurate and reliable driving tube estimate can form a foundation for many types of different assistance systems and/or an at least partially automated guidance of the motor vehicle, effort and energy can thus be saved without disadvantage and/or improved safety and/or improved comfort can be enabled particularly easily. For example, an update of the driving tube estimate can thus also be carried out, for example, in less than 1 millisecond (ms) on average even using computational hardware currently typical in motor vehicles. It is thus accordingly possible to react rapidly to new measurement data or a changed traffic situation of the motor vehicle.

The traffic situation of the motor vehicle can be provided by a surroundings situation or the surroundings of the motor vehicle. The traffic situation can also comprise the respective current state of the motor vehicle, thus, for example, its position, velocity, steering angle, and/or more of the like. The surroundings can be provided or described here, for example, by the respective local traffic infrastructure, presence and possibly positions of surrounding features, objects, obstacles, other road users, or the like as well as their sensory recognizability. Corresponding features or objects in the surroundings can be or comprise, for example, roadway or lane markings, curbs, a road or roadway course, elements of road equipment, road or roadway edges, guide rails, vegetation strips, and/or the like.

The problem dealt with and the concept proposed here for its solution can thus be summarized as follows, which will also be explained in more detail hereinafter: The matrix inversion for large matrices is very complex in principle. This relates to the measurement uncertainty matrix respectively to be inverted in previous methods for the update, which is very much larger than the state uncertainty matrix. The estimation problem can be formulated on the basis of information matrix and information vector. The information filter can therefore be applied at least as part of the solution. An independent observation of individual measurements can take place here. Therefore, instead of the inversion of the comparatively large overall measurement uncertainty matrix for the update, an inversion of multiple comparatively very much smaller measurement uncertainty matrices can be carried out. The final inversion of the possibly comparatively small information matrix to transfer the updated estimate into the state space is—in comparison to inverting the entire measurement uncertainty matrix—linked to significantly less effort.

In one or more possible embodiments of the present disclosure, the measurement data describe at least the road course lying ahead of the motor vehicle in its direction of travel at different distances from the motor vehicle, thus from its respective current position. The measurement data can thus characterize, map, or scan the respective surroundings or road, for example, with a resolution in the range of centimeters or decimeters or in the order of magnitude of one meter (m), for example, up to a distance of several tens of meters. The surroundings or the upcoming road course can thus be recognized particularly accurately, which can ultimately also enable a particularly accurate, robust, and reliable estimate of the driving tube. The use of such detailed measurement data as the basis for estimating the driving tube is enabled here by the particularly efficient data processing. Thus, the particularly efficient driving tube estimate is without significant disadvantages over other approaches, which with given computing capacity or computing hardware can possibly only process less or less detailed measurement data in real time.

In one or more further possible embodiments of the present disclosure, the measurement data are organized in a measurement data vector and the associated uncertainties are organized in an uncertainty matrix. In the updating step, the individual measurement data and their associated uncertainties are considered independently of one another, without inverting the entire uncertainty matrix. For example, individual submatrices of the overall uncertainty matrix corresponding to the individual measurement data can be inverted individually instead of inverting the entire uncertainty matrix. These submatrices can have, for example, the dimension 3×3 or 4×4, while the dimension of the overall uncertainty matrix can be in the order of magnitude of 100×100 or more. In particular, the dimension of the submatrices can be an integer divider of the dimension of the overall uncertainty matrix. The advantage of the information filter formalism can thus be utilized here that measurements or individual measurement data can be filtered in each pass or time step of the method by summing the corresponding information matrices and information vectors. Individual measurement data can be individual measurement points or data points from one or more data sources. A single sensor can supply a single measurement datum or multiple individual measurement data upon each new measurement here. The one or more embodiments of the present disclosure proposed here offers an approach which is simple to implement in order to estimate the driving tube without accuracy loss and at the same time to avoid the computing effort or data processing effort for inverting the overall uncertainty matrix.

In one or more further possible embodiments of the present disclosure, initially a corresponding updated state or state vector for the driving tube is determined from the updated information matrix and the updated information vector. This state or state vector characterizes or describes the driving tube by way of predetermined, in particular geometric parameters. The number of these predetermined parameters is less, in particular very much less than the dimension of the measurement data or the measurement space in which the measurement data and their uncertainties are specified. Upon an organization of the measurement data into vector or matrix form, for example, dozens or hundreds of rows or also columns can exist. The number of the predetermined parameters for characterizing or describing or specifying the driving tube or the state or state vector for the driving tube, in contrast, can be, for example, at most 20 or at most 10, for example, 4. The number of the parameters can thus be, for example, at most a fifth or at most a tenth of the number of the rows of the measurement data vector or the associated uncertainty matrix. In this way, the driving tube, thus its respective current estimate, can be specified or handled with particularly little data processing effort.

In one possible refinement of the present disclosure, the predetermined parameters for characterizing the driving tube comprise its curvature, in particular at multiple predetermined distances from the motor vehicle or from its respective current position, thus at multiple points spatially spaced apart from one another in the direction of travel of the motor vehicle or in the longitudinal direction or along the longitudinal extension of the driving tube. The driving tube or its course can thus be described or specified particularly easily, efficiently, and with little data. Such a characterization of the driving tube can be sufficient for practical purposes, since certain properties of the driving tube or corresponding boundary conditions for the course of the driving tube may be provided or met, thus can accordingly be predetermined. This can comprise, for example, that the driving tube runs on the local roadway surface, can have a predetermined width, can have at most maximum curvature which is predetermined or defined by the technical properties of the motor vehicle, for example, has to run continuously, thus without interruption, cannot have any jumps, steps, or lateral offsets, and/or the like. The predetermined parameters for characterizing the driving tube can likewise comprise, for example, its radius, length, width, orientation, and/or the like. The respective values of these parameters can be specified or entered, for example, in the state vector mentioned at another point. This can enable particularly simple and efficient data processing.

In one possible refinement of the present disclosure, the last determined updated information matrix is inverted to determine the updated state of the driving tube. This inverted information matrix is then multiplied by the respective last determined updated information vector. This represents a particularly simple and low-effort possibility for describing the driving tube or its state or estimate by real, clearly comprehensible, for example, geometric variables, thus for specifying it in a correspondingly clear and practical state space. This can enable particularly simple and efficient further use of the respective current driving tube estimate by other assistance systems and assistance functions. For example, the latter can then be implemented independently of the formalism used for the driving tube estimate.

In one possible refinement of the present disclosure, a corresponding updated estimated course of the driving tube in the respective surroundings is determined from the updated state of the driving tube by a predetermined model. The predetermined model models or considers here at least one predetermined condition for a permissible real driving tube course. The model can thus, for example, model the properties or boundary conditions for the driving tube course mentioned at another point. From the combination of the state, which can be specified, for example, by fundamental or punctiform parameter values, and the at least one predetermined condition, the complete driving tube course can thus be determined by the model, for example, as a two-dimensional or three-dimensional longitudinally extended geometrical object, which can be located, for example, relative to the respective current position of the motor vehicle and/or in a predetermined, for example, world-fixed coordinate system. The model can thus specify or model how a real course of the driving tube results from the respective measurement data or the state or state vector of the driving tube estimated therefrom. The model can be stored or implemented, for example, in an estimating unit, which is configured to estimate the state of the driving tube. The model can build up the real driving tube course based on the respective current state, for example, from circle segments or curved lines or the like. It can be predetermined as a condition here, for example, that transitions between successive circle segments or curved lines are to be smooth, these circle segments or curved lines adjoin one another or merge into one another without a jump, offset, or spacing. This can enable particularly efficient modeling of the real driving tube course.

In one or more further possible embodiments of the present disclosure, surroundings data are acquired as part of the measurement data. These surroundings data describe the respective surroundings of the motor vehicle, in particular lying ahead in the direction of travel of the motor vehicle. Furthermore, steering angle data of the motor vehicle are acquired as part of the measurement data. These steering angle data can specify or comprise, for example, a current steering angle or also a current change of the steering angle, thus, for example, its direction of change and/or speed of change. Furthermore, it is then ascertained whether a lane change maneuver or a turnoff maneuver of the motor vehicle is expected to take place in a range from the respective current position of the motor vehicle up to a predetermined distance from the motor vehicle in its direction of travel. This can be carried out, for example, on the basis of navigation data, a driving history of the motor vehicle and/or the respective driver, a corresponding predetermined movement model, and/or more of the like.

If it is ascertained that such a maneuver is expected to be upcoming, the updated estimate of the driving tube is determined up to the predetermined distance based on the steering angle data and from the predetermined distance based on the surroundings data without consideration of the steering angle data. Up to the predetermined distance, the driving tube can thus be estimated, for example, based on the steering angle data or based on the steering angle data and the surroundings data. This can enable a particularly accurate and reliable estimate of the driving tube up to the predetermined distance, since the steering angle in the corresponding close range primarily determines and limits the movement direction of the motor vehicle.

At the same time, because the steering angle data remain unconsidered from the predetermined distance, the more remote driving tube course adjoining thereon can also be estimated particularly reliably, since unforeseen steering angle changes or steering maneuvers can occur between the current position of the motor vehicle and the predetermined distance, so that the current steering angle data at the current position of the motor vehicle do not form a reliable foundation for the estimate of the driving tube course from the predetermined distance.

Therefore, by way of the one or more embodiments of the present disclosure proposed here, a particularly accurate and reliable estimate of the driving tube with particularly low computing effort or data processing effort can thus be enabled both in close range up to the predetermined distance and at long range going beyond this.

The predetermined distance can be dependent, for example, on the respective motor vehicle or its technical properties and/or the respective surroundings and/or the current speed of the motor vehicle and/or more of the like. The predetermined distance can thus be dynamically predetermined, thus automatically dynamically adapted accordingly in operation of the motor vehicle. The predetermined distance can also be predetermined as a fixed value. The predetermined distance can be, for example, between 10 m and 30 m, for example 15 m. Other values can also be possible depending on the application.

For example, a greater distance can be predetermined or set for a smaller maximum possible steering angle and/or a smaller maximum possible steering angle change speed of the motor vehicle. A greater distance can also be predetermined or set for a greater speed of the motor vehicle. A greater distance can also be predetermined or set, for example, on a freeway or a road constructed similarly to a freeway than in urban areas. A driving tube estimate which is particularly adapted to the situation, thus optimized in different situations or surroundings, can thus be enabled.

The present disclosure further relates to an assistance system for a motor vehicle. The assistance system according to the disclosure comprises an interface—implemented in hardware and/or software—for acquiring measurement data which characterize a traffic situation of the motor vehicle. Furthermore, the assistance system according to the disclosure comprises a processing unit, thus, for example, a microchip, microprocessor, or microcontroller or the like, and a computer-readable data memory coupled thereto. The assistance system according to the disclosure is configured here to carry out, in particular automatically, the method according to the disclosure. The assistance system according to the disclosure can thus be configured for a regular or continuous or quasi-continuous estimate or prediction, for example, dependent on a measuring or recording frequency of the measurement data, of the driving tube of the motor vehicle or an update of the estimated or predicted driving tube of the motor vehicle. A corresponding operating or computer program can be stored for this purpose in the data memory, which codes or implements the method steps, measures, or sequences or corresponding control instructions mentioned in conjunction with the method according to the disclosure. This operating program or computer program can then be executable by the processing unit in order to carry out the corresponding method or cause it to be carried out.

The present disclosure further relates to a motor vehicle which comprises a surroundings sensor system for recording surroundings data and an assistance system according to the disclosure. The surroundings data can be data which describe or characterize respective surroundings of the motor vehicle, in particular lying ahead thereof in the direction of travel of the motor vehicle. The surroundings sensor system can be part of the assistance system or can be connected thereto, for example, by an onboard network of the motor vehicle. The motor vehicle according to the disclosure can in particular be or correspond to the motor vehicle mentioned in conjunction with the method according to the disclosure and/or in conjunction with the assistance system according to the disclosure.

Further features are disclosed in the figures and the description of the figures. The features and combinations of features mentioned above in the description and the features and combinations of features shown hereinafter in the description of the figures and/or solely in the figures are usable not only in the respective specified combination, but also in other combinations or alone, without leaving the scope of the disclosure.

### BRIEF DESCRIPTION OF THE DRAWING

FIG. 1 shows an exemplary schematic overview representation of a traffic situation to illustrate an information filter-based driving tube estimate for a vehicle.

### DETAILED DESCRIPTION OF THE DRAWING

The identification of objects which are relevant to the longitudinal and/or lateral control of a vehicle can use a recognition of the possible driving tube of the vehicle, to which recognized objects can then be set in relation. In order to ensure a high level of availability of the driving tube or a respective current estimate of the driving tube in a wide variety of traffic situations and road conditions, a predetermined fusion algorithm can be used for the corresponding fusion of different measurement data or input data from different data sources, such as smart, heterogeneous sensors or the like. Different aspects of the respective surroundings, thus the respective surroundings, such as data on lane markings, roadside structures, turf, curb stones and/or more of the like can thus be acquired and combined to form a consistent overall image of the driving tube. Objects, in particular moving objects, recognized in the respective surroundings can then be assigned to the driving tube. Moving objects, in particular those assigned to the driving tube, in the surroundings of the vehicle can be used or taken into consideration, for example, for longitudinally-controlling functions, such as ACC, intersection assistant, adaptive recuperation, and/or more of the like, and also for laterally-controlling functions such as steering and lane keeping assistants or the like.

Previous approaches have often been based on the approach that the driving tube of the vehicle, if it is not known from a planning component of a system for automated vehicle guidance, corresponds with the course of the currently traveled road or the currently traveled lane where the vehicle is located and has to be determined with the aid of sensors acquiring the respective surroundings. This course can be determined, for example, in a recursive estimation process, which compares a respective current concept or estimate of the course of the road or the respective lane to lane markings recognized in sensor data, for example, in camera images.

The problem of determining or estimating the respective upcoming driving tube or its course is thus to be solved. Corresponding estimation processes have typically previously worked in the corresponding state space of the solutions, where the uncertain state is updated with each uncertain measurement, thus with each recording or acquisition of uncertain measurement data or, for example, with each recognition of lane markings or of the road or lane course subject to uncertainties, or the like. This state can be specified, for example, by parameters or parameter values of a parametric representation of the geometry of the road or the traveled lane. With such an update, the estimated state can be better brought into correspondence with the respective measurement or adapted to the measurement and at the same time the uncertainty of the estimate of the state can be reduced. In previous approaches, the uncertainties of the measurements or the measurement data are typically represented on the basis of high-dimensional matrices of the covariances of the measured variables.

One disadvantage of the previous approach then becomes more clear the more different measurements or measurement data, for example, measurement data from different sensors or finely resolved measurement data of the road course at different distances from the vehicle, are to be taken into consideration in the estimation process. The updating of the estimate by taking into consideration the respective new measurements or measurement data can then in previous approaches require the inversion of a correspondingly high-dimensional matrix, which represents the uncertainties of the measurements. Such a matrix can have a size of 500×500, for example. An inversion or inverting of such matrices can require a substantial computing effort, wherein in particular embedded systems, as current driver assistance systems are often based on, can only offer very limited computing time or computing power at the same time, however.

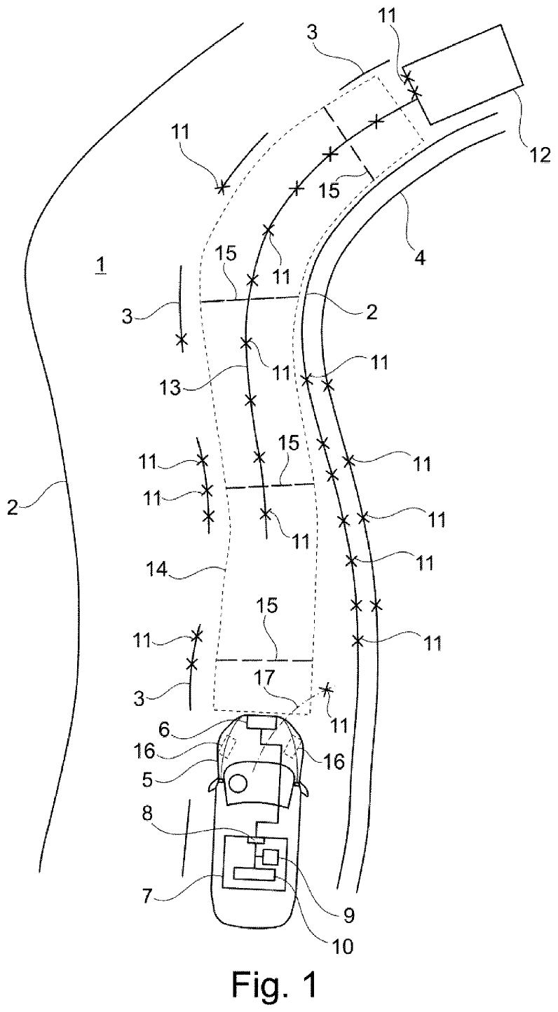

Against this background, FIG. 1 shows an exemplary schematic and detail overview illustration of a traffic situation. Specifically, a detail of a road 1 is shown, which is delimited by roadway edges 2. There are two lanes here by way of example on the road 1, which are delimited from one another by a lane marking 3. Furthermore, a guide rail 4 extends here along one of the roadway edges 2.

A motor vehicle 5 moves on the road 1. This motor vehicle 5 can be equipped with assistance functions, which use a respective current driving tube of the motor vehicle 5 as a data foundation. The motor vehicle 5 is configured for a continuous or regular estimate of the driving tube or a corresponding update of the estimate of the driving tube. For this purpose, the motor vehicle 5 comprises a surroundings sensor system 6 and an assistance system 7. The assistance system 7 can acquire surroundings data recorded by the surroundings sensor system 6, as well as further data, such as steering angle data of the motor vehicle 5, via an interface 8. To process these data to estimate the driving tube, the assistance system 7—as schematically indicated here by way of example—can comprise a processor 9 and a computer-readable data memory 10.

The acquired data can be of different types, can originate from different sources, and can characterize or describe the surroundings of the motor vehicle 5 at different points. For example, multiple corresponding data points or measurement points 11 are represented here, of which a selection is explicitly identified for the sake of clarity, however. The data points or measurement points 11 can originate, for example, from an external vehicle 12 also traveling on the road 1, describe its trajectory 13, comprise one or more points on a driving path 17 of the motor vehicle 5 derived from the current steering angle or a current position of steered wheels 16 of the motor vehicle 5, thus projected into the future based on the steering angle, can be or represent measurements or detections of the roadway edge 2, the lane marking 3, the guide rail 4, and/or more of the like.

Based thereon, the assistance system 7 progressively repeatedly ascertains a respective current driving tube estimate 14, which is also schematically illustrated here, during operation of the motor vehicle 5. The respective driving tube estimation 14 can be described by comparatively few parameters—in comparison to the number or dimension of the respective data acquired as the basis for the driving tube estimate 14. A state to be estimated for the driving tube can include, for example, four parameters, each of which indicates the curvature of the driving tube at different distances, which are represented here by way of example as support points 15. The assistance system 7 can then describe, thus determine, the complete course of the driving tube, thus the complete driving tube estimate 14 for the motor vehicle 5 by a predetermined model, for example, stored in the data memory 10, which uses this respective estimated state as the input. The respective current driving tube estimate 14 can then be stored, for example, in the data memory 10 and/or provided or transmitted via the interface 8.

Proceeding from the observation that the dimension of the corresponding state space, which is spanned by the parameters to describe the state or course of the driving tube, is smaller, in particular very much smaller than the dimension of the measurement space in which the acquired data or their uncertainties are specified or represented, a determination or update of the driving tube estimate 14 which is simplified, less computing-intensive, and therefore more efficient can be carried out. For this purpose, the information vector and the associated information matrix are estimated by the assistance system 7 in the context of the information filter formalism based on the respective acquired data, instead of estimating the state of the driving tube and the associated uncertainty directly. The application of the information filter is thus provided here, wherein the respective update of the driving tube estimate 14 is possible, thus can be carried out, without a complex inversion or inverting of the entire uncertainty matrix of the acquired data. Instead, the individual acquired data or measurements or measurement data, for example of the individual measurement points 11, are taken into consideration independently of one another in the respective updating step. The inversion of the entire uncertainty matrix can effectively be replaced here by inversions of corresponding smaller matrices, which are simpler to calculate. The estimate of the respective state can then be obtained from the information vector after inversion or inverting of the comparatively low-dimensional information matrix.

For a first starting point, thus a first driving tube estimate 14 upon or after startup of the motor vehicle 5, for example, a simplified driving tube estimate 14 can be determined based on the current steering angle of the motor vehicle 5, which can then be progressively updated as described, in particular in consideration of surroundings data or an estimate based thereon of the course of the road 1 lying ahead of the motor vehicle 5 in the direction of travel. Proceeding from an original driving tube based on the current steering angle of the motor vehicle 5, the estimate of the parameters specifying the state of the driving tube, thus, for example, the mentioned curvatures at the multiple support points 15, can thus be adapted in a progressive process to the respective most recently acquired data or the respective most recent measurement or estimate of the actual road course of the road 1.

For this purpose, at each point in time, a large number of different types of measurements from different sensors can be available, which can all be brought into a standard form for the data fusion. Such measurements can be or comprise or specify, for example, radio waves which are reflected on building structures or devices along the road or roadway edge 2, such as the guide rail 4, back to a radar sensor of the surroundings sensor system 6, markings, such as the roadway marking 3, and/or vegetation strips or turf or the like, which are recognized in camera images of a camera of the surroundings sensor system 6, the trajectory 13 of the respective preceding external vehicle 12, a collective movement of other road users in the respective surroundings, the steering angle or the steering angle change of the motor vehicle 5, its position, orientation, movement direction and speed, and/or more of the like.

Therefore, for example, per updating step, several hundred uncertain measurements, for example, in the form of a specific angle specification of a road course of the road 1 can be provided in a specific one of multiple different distances for the fusion. By transferring the problem into the information space, thus the expression by the information vector and the information matrix, and applying the information filter, the respective update can be carried out with particularly little computing effort and therefore also particularly quickly or also with correspondingly less computing resources, in particular in real time. This can enable, for example, an execution of such an updating step on an embedded system or control unit on average, in particular even in unfavorable cases, in at most 1 ms.

A combination of the estimate of the driving tube, the description of the state of the driving tube by parameters—few in comparison to the respective acquired data—in particular geometric parameters, for example, at most 20 parameters, and the information filter formalism is thus proposed here. A large number of different input data can thus also be processed particularly easily, with little effort, and quickly to form the respective current driving tube estimate 14.

Overall, the described examples show how a runtime-optimized data fusion can be implemented to determine the driving tube, in particular also on embedded systems.

### LIST OF REFERENCE SIGNS

1 road
2 roadway edge
3 lane marking
4 guide rail
5 motor vehicle
6 surroundings sensor system
7 assistance system
8 interface
9 processor
10 data memory
11 measurement points
12 external vehicle
13 trajectory
14 driving tube estimate
15 support point
16 steered wheels
17 driving path

1-10. (canceled)

11. A method for estimating a driving tube of a motor vehicle, comprising:
acquiring multiple measurement data corresponding to a respective traffic situation of the motor vehicle, wherein the multiple measurement data is acquired with associated uncertainties;
estimating an updated information matrix and an updated information vector of an information filter formalism that considers the multiple measurement data and the associated uncertainties; and
determining an updated estimate of the driving tube based on the updated information matrix and the updated information vector.

12. The method according to claim 11, wherein the multiple measurement data describes, at least, a road course lying ahead of the motor vehicle in a direction of travel at one or more distances from the motor vehicle.

13. The method according to claim 11, further comprising:
organizing the measurement data in a measurement data vector; and
organizing the associated uncertainties in an uncertainty matrix, wherein each of the multiple measurement data and their respective associated uncertainties are considered independently of other of the multiple measurement data and the associated uncertainties without inverting all of the uncertainty matrix.

14. The method according to claim 11, wherein an updated state for the driving tube is initially determined from the updated information matrix and the updated information vector based on one or more geometric parameters associated with the driving tube, wherein a number of the one or more geometric parameters is less than a dimension of the measurement data.

15. The method according to claim 14, wherein the one or more geometric parameters associated with the driving tube comprise a curvature of the driving tube at one or more predetermined distances from the motor vehicle.

16. The method according to claim 14, wherein determining the updated state of the driving tube comprises:
inverting a last determined updated information matrix; and
multiplying the inverted last determined information matrix by a last determined updated information vector.

17. The method according to claim 14, further comprising:
determining a corresponding updated course of the driving tube in respective surroundings of the motor vehicle from the updated state by a predetermined model, wherein the predetermined model models at least one predetermined condition for a permissible real driving tube course.

18. The method according to claim 14, further comprising:
acquiring surroundings data and steering angle data of the motor vehicle as part of the multiple measurement data, wherein the surroundings data corresponds to surroundings of the motor vehicle;
ascertaining whether a lane change maneuver or a turnoff maneuver of the motor vehicle is expected to take place in a range from a current position of the motor vehicle to a predetermined distance from the motor vehicle in its direction of travel; and
determining the updated estimate of the driving tube to the predetermined distance based on the steering angle data and beyond the predetermined distance based on the surroundings data without considering the steering angle data.

19. An assistance system for a motor vehicle, comprising:
an interface for acquiring measurement data corresponding to a traffic situation of the motor vehicle;
a processor; and
a computer-readable data memory coupled thereto,
wherein the assistance system is configured to carry out a method for estimating a driving tube of the motor vehicle, comprising:
acquiring multiple measurement data corresponding to a respective traffic situation of the motor vehicle, wherein each of the multiple measurement data is acquired with associated uncertainties;
estimating an updated information matrix and an updated information vector of an information filter formalism that considers the multiple measurement data and the associated uncertainties; and
determining an updated estimate of the driving tube based on the updated information matrix and the updated information vector.

20. The assistance system according to claim 19, wherein the multiple measurement data describes, at least, a road course lying ahead of the motor vehicle in a direction of travel at one or more distances from the motor vehicle.

21. The assistance system according to claim 19, wherein the method further comprises:
organizing the measurement data in a measurement data vector; and
organizing the associated uncertainties in an uncertainty matrix, wherein each of the multiple measurement data and their respective associated uncertainties are considered independently of other of the multiple measurement data and the associated uncertainties without inverting all of the uncertainty matrix.

22. The assistance system according to claim 19, wherein an updated state for the driving tube is initially determined from the updated information matrix and the updated information vector based on one or more geometric parameters associated with the driving tube, wherein a number of the one or more geometric parameters is less than a dimension of the measurement data.

23. The assistance system according to claim 22, wherein the one or more geometric parameters associated with the driving tube comprise a curvature of the driving tube at one or more predetermined distances from the motor vehicle.

24. The assistance system according to claim 22, wherein determining the updated state of the driving tube comprises:
inverting a last determined updated information matrix; and
multiplying the inverted last determined information matrix by a last determined updated information vector.

25. The assistance system according to claim 22, wherein the method further comprises:
determining a corresponding updated course of the driving tube in respective surroundings of the motor vehicle from the updated state by a predetermined model, wherein the predetermined model models at least one predetermined condition for a permissible real driving tube course.

26. The assistance system according to claim 22, wherein the method further comprises:
acquiring surroundings data and steering angle data of the motor vehicle as part of the multiple measurement data, wherein the surroundings data corresponds to surroundings of the motor vehicle;
ascertaining whether a lane change maneuver or a turnoff maneuver of the motor vehicle is expected to take place in a range from a current position of the motor vehicle to a predetermined distance from the motor vehicle in its direction of travel; and
determining the updated estimate of the driving tube to the predetermined distance based on the steering angle data and beyond the predetermined distance based on the surroundings data without considering the steering angle data.

27. A motor vehicle, comprising:
a surroundings sensor system for recording surroundings data;
and an assistance system, comprising:
an interface for acquiring measurement data corresponding to a respective traffic situation of the motor vehicle;
a processor; and
a computer-readable data memory coupled thereto,
wherein the assistance system is configured to carry out a method for estimating a driving tube of the motor vehicle, comprising:
acquiring multiple measurement data corresponding to a traffic situation of the motor vehicle, wherein each of the multiple measurement data is acquired with associated uncertainties;
estimating an updated information matrix and an updated information vector of an information filter formalism that considers the multiple measurement data and the associated uncertainties; and
determining an updated estimate of the driving tube based on the updated information matrix and the updated information vector.

28. The motor vehicle according to claim 27, wherein the multiple measurement data describes, at least, a road course lying ahead of the motor vehicle in a direction of travel at one or more distances from the motor vehicle.

29. The motor vehicle according to claim 27, wherein the method further comprises:
organizing the measurement data in a measurement data vector; and
organizing the associated uncertainties in an uncertainty matrix, wherein each of the multiple measurement data and their respective associated uncertainties are considered independently of other of the multiple measurement data and the associated uncertainties without inverting all of the uncertainty matrix.

30. The motor vehicle according to claim 27, wherein an updated state for the driving tube is initially determined from the updated information matrix and the updated information vector based on one or more geometric parameters associated with the driving tube, wherein a number of the one or more geometric parameters is less than a dimension of the measurement data.
